(19) United States
(12) Patent Application Publication
(10) Pub. No.: US 2002/0063237 A1
(43) Pub. Date: May 30, 2002

(54) Esters and ester compositions

(75) Inventors: Ronald Hoogendoorn, Wilmington, DE (US); Jos Van Lint, Lopik (NL); Marian Steverink-De-Zoete, Leidschendam (NL); Ron Van Aken, Nieuwerkerk aan de ljssel (NL)

Correspondence Address: Pillsbury Whinthrop LLP, Intellectual Property Group, 1600 Tyson's Boulevard, McLean, VA, 22102, US

(73) Assignee: Imperial Chemical Industries Plc, London (GB)

(21) Appl. No.: 10/006,368

(22) Filed: Dec. 10, 2001

Related U.S. Application Data
(63) Continuation of application No. PCT/GB00/02207, filed on Jun. 7, 2000.

(30) Foreign Application Priority Data
Jun. 9, 1999 (GB) 99111209.5

(51) Int. Cl. C09K 5/00

(52) U.S. Cl. 252/71

(57) ABSTRACT

The invention relates to new esters and ester compositions based on a polyol, a dicarboxylic acid and a monocarboxylic acid, a process for their preparation and their use in hydraulic fluids and metal working fluids. The new esters and ester compositions have improved clean burning and lubricity properties when used in/as metal working fluids, especially rolling fluids. The new esters and ester compositions have improved biodegradability and thermal and oxidative stability properties when used in/as hydraulic fluids.

The present invention relates to new esters and ester compositions based on a polyol, a dicarboxylic acid and a monocarboxylic acid, a process for their preparation and their use in hydraulic fluids and metal working fluids.

Esters based on a polyol, a dicarboxylic acid and a monocarboxylic acid are known from WO99/16849, which describes esters having a kinematic viscosity at 100° C. (V_{K,100}) of 30 mm²/s and higher. These esters are known are complex esters.

EP649457B discloses complex esters, which are blended with adipic acid derived diesters. The combination of the complex esters with the diesters leads to specific benefits for hydraulic fluid applications, namely high viscosity index, improved pour point and the ability to change blend concentrations and hence vary viscosities.

Surprisingly, it was found that, by using a specified diol, dicarboxylic acid and monocarboxylic acid, an ester or ester composition may be obtained which has a low viscosity at 40° C. and 100° C. and which is suitable as lubricant in metal working fluids, in particular rolling fluids, and in hydraulic fluids.

The present invention is concerned with an ester or ester composition with the formula:

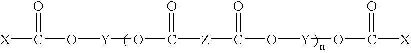

wherein

X is an aliphatic hydrocarbyl group having 5-11 carbon atoms;

Y is an alkylene group having 2-8 carbon atoms;

Z is an aliphatic hydrocarbyl group having 3-5 carbon atoms and

n is a weight average number in the range 1 to 10.

The group X may be saturated or unsaturated and linear or branched. Preferably X is saturated and linear. The group X may be derived, by removal of the —COOH group, from for example hexanoic acid, heptanoic acid, octanoic acid, nonanoic acid and decanoic acid and mixtures thereof. In a preferred aspect, X has 7-9 carbon atoms. In a more preferred aspect, X is derived, by removal of the —COOH group, from octanoic and decanoic acid and mixtures thereof.

The group Y may be saturated or unsaturated, linear or branched and/or may contain an ether linkage. Preferably it is saturated and branched. The group Y may be derived from, by removal of the two —OH groups, for example ethylene glycol, propylene glycol, butane diol, diethylene glycol, pentane diol, neopentyl glycol, hexane diol, heptane diol and mixtures thereof. In a preferred aspect, Y has 4-6 carbon atoms. In a more preferred aspect, Y is derived from neopentyl glycol by removal of the two —OH groups.

The group Z may be saturated or unsaturated, linear or branched. Preferably it is linear and saturated. The group Z may be derived, by removal of the two —COOH groups, from for example glutaric acid, adipic acid, pimelic acid and mixtures thereof. In a preferred aspect, Z has 4 carbon atoms. In a more preferred aspect, Z is derived from adipic acid by removal of the two —COOH groups.

The suffix n is preferably in the range 1.5-5.

The esters and ester compositions, according to the present invention, may be used as lubricants in metal working fluids, more particularly in rolling fluids where they show an improved lubricating and clean burning performance. Further, they may be used as lubricants in hydraulic fluids exhibiting amongst other features a low viscosity at low temperature, a good oxidative stability, a good thermal stability and good biodegradability.

The kinematic viscosity of the esters is preferably below 20 mm²/s at 100° C. and below 150 mm²/s at 40° C.

The esters and ester compositions, according to the present invention, are prepared by reacting a monocarboxylic acid having a group X, with a diol having a group Y and a dicarboxylic acid having a group Z. The reaction may be conducted under reduced pressure and slightly elevated temperature or at atmospheric pressure between 200-250° C. In a preferred aspect the reaction is conducted at atmospheric pressure between 200-250° C.

The relative amounts of the reactants are so chosen as to obtain esters or ester compositions in which n is in the specified range.

Preferably the ratio of OH groups to COOH groups in the reaction mixture, at the start of the reaction, is in the range 0.9:1-1.1:1 and more preferably in the range 0.95:1-1.05:1. Ideally, this ratio is about 1:1.

The ratio of COOH groups from the monocarboxylic acid to those from the dicarboxylic acid in the reaction mixture, at the start of the reaction, is preferably in the range 0.3:1-1.5:1 and more preferably in the range 0.4:1-1:1.

During the reaction water, some monocarboxylic acid and diol are distilled off. The monocarboxylic acid is fed back into the reaction mixture and the water containing the diol is removed.

The reaction is continued till the hydroxyl value is below 20 mg KOH/g, preferably below 15 mg KOH/g.

After the reaction, any excess of monocarboxylic acid is removed by distillation.

The ester and ester compositions according to the present invention may be used in lubricants in particular in metal working and especially in rolling fluid. They may be used as base fluids or additives in such metal working and especially rolling fluids. The base fluids and additives may comprise other ingredients commonly used in metal working and especially in rolling fluids which are known to those skilled in the art. Examples of these other ingredients include mineral oils, oils of vegetable and/or animal origin and other synthetic esters, surfactants, emulsifiers, corrosion inhibitors, anti-oxidants, anti-wear/EP-agents and anti-foaming agents.

The amount of the esters and ester compositions according to the present invention in such base fluids ranges from 5 to 70% by weight and preferably from 10 to 50% by weight calculated on the weight of the base fluid. Further such esters and base fluids may be used in metal working and especially rolling fluids comprising water wherein the metal working/rolling fluid:water is 99:1 to 1:99 and preferably 20:80 to 2:98.

The ester and ester compositions according to the present invention may further be used as or in hydraulic fluids comprising up to 5% by weight and preferably 2-5% by weight of other ingredients commonly used in hydraulic fluids known to those skilled in the art. Examples of such ingredients include metal deactivators, corrosion inhibitors, anti-wear/EP-agents, anti-foam agents, anti-oxidants and emulsifiers.

The invention will be further illustrated by reference to the following examples.

### EXAMPLE 1

21 kg of a mixture of octanoic and decanoic acid (60/40%, w/w), 20 kg of neopentyl glycol and 19 kg of adipic acid were fed into an autoclave, mixed, heated to 230° C. at atmospheric pressure and allowed to react. The process was conducted under a N₂ blanket. During the reaction water formed, which together with some diol and some monocarboxylic acid was distilled off. The monocarboxylic acid was fed back into the reactor. The reaction was allowed to proceed until the OH-value was below 15 mg KOH/g. Then, excess monocarboxylic acid was removed by applying a vacuum (400-500 mbar). Finally, the mixture was stripped under N₂ (1 hour, 230° C., 400-500 mbar), cooled to 80° C. and, after addition of 125 g of Dicalite™ 478 (filter aid from Lafarge Redland Minerals), filtered. 6.9 kg of water, 1.6 kg of monocarboxylic acid and 51.5 kg of an ester according to the invention were obtained. This ester has an n value of about 3.5, a kinematic viscosity at 40 and 100° C. of 91 and 13 mm²/s respectively and an acid value of 28 mg KOH/g.

### EXAMPLE 2

Example 1 was repeated with 26.1 kg of the octanoic/decanoic acid mixture, 19 kg of neopentyl glycol and 14.9 kg of adipic acid.

6.6 kg of water, 0.8 kg of monocarboxylic acid and 52.6 kg of an ester according to the invention were obtained. The ester has an n value of about 2.2, a kinematic viscosity at 40 and 100° C. of 46 and 8 mm²/s respectively and an acid value of 21 mg KOH/g.

### EXAMPLE 3

Example 1 was repeated with 19 kg of the octanoic/decanoic acid mixture, 20.75 kg of diethylene glycol and 20.25 kg of adipic acid. In this case the reaction was allowed to proceed until the OH-value was below 20 mg KOH/g before the vacuum distillation removal of excess monocarboxylic acid.

6.5 kg of water, 0.8 kg of monocarboxylic acid and 52.7 kg of an ester according to the invention were obtained. The ester has an n value of about 2.4, a kinematic viscosity at 40 and 100° C. of 80 and 13 mm²/s respectively and an acid value of 27 mg KOH/g.

### EXAMPLE 4

Table 1 illustrates the clean burning and lubricity properties of the esters of Examples 1, 2 and 3 used in rolling fluids.

20 to 25 mg of the material was heated, in a 150 μl alumina cup, from 30 to 500° C. at a rate of 10° C./min under a nitrogen flow of 100 ml/min. The temperature at which the evaporation loss was 50% was measured.

Saponification values were measured according ASTM D1962-85.

The material was subjected to the four-ball machine test in accordance with ASTM D-2783-88, except that the rotation speed was 1500 rpm, in order to evaluate its weld load performance

TABLE 1

| | | Saponi- | Evaporation | 4 ball |
|---|---|---|---|---|
| | Kinematic | fication | loss | failure |
| | Viscosity | Value | temp at 50% | load |
| Ester | (mm²/s) | (mgKOH/g) | Evaporation (° C.) | (Newton) |
| Example 1 | 91 | 411 | 391 | 1500 |
| Ester | | | | |
| Example 2 | 46 | 390 | 347 | 1300 |
| Ester | | | | |
| Example 3 | 82 | 420 | 381 | 1400 |
| Ester | | | | |
| PRIOLUBE | 52 | 185 | 444 | 900 |
| 1422 | | | | |
| (compara- | | | | |
| tive) | | | | |
| PRIOLUBE | 85 | 180 | 436 | 900 |
| 2044 | | | | |
| (compara- | | | | |
| tive) | | | | |
| Cocos oil | 28 | 256 | 390 | 900 |
| (compara- | | | | |
| tive) | | | | |
| Tallow oil | 45 | 197 | 414 | 1000 |
| (compara- | | | | |
| tive) | | | | |
| Vitrea 32 | 32 | 0 | Not measured | 700 |
| (compara- | | | | |
| tive) | | | | |

PRIOLUBE 1422 is trimethylolpropane ester of tallow fatty acid available ex Uniqema, an ICI Business

PRIOLUBE 2044 is trimethylolpropane ester of modified fatty acid available ex Uniqema.

Cocos oil is a triglyceride of cocos fatty acids

Tallow oil is a triglyceride of tallow fatty acids

Vitrea 32 is a SN 150 grade mineral oil available ex Shell

Examples 1,2 and 3 demonstrate that the use of esters in accordance with the invention has improved clean burning and lubricity properties with respect to the comparative esters and mineral oil.

### EXAMPLE 5

Example 1 was repeated with 18.2 kg of neopentyl glycol, 13.7 kg of adipic acid and 24.2 kg of the octanoic/decanoic acid mixture. The reaction was conducted at 225° C. for about 8 hours; when the acid value was below 20 mg KOH/g (after about 5 hours) 2.7 gram of catalyst (20 parts by weight of tetrabutyl titanate in 80 parts by weight of di-2-ethylhexyl-azelate) was added.

6.1 kg of water and 50.0 kg of an ester according to the invention (n is about 2.1) was obtained. The ester had a kinematic viscosity at 40° C. and 100° C. of 45 mm²/s and 8 mm²/s respectively and an acid value below 1 mg KOH/g.

### EXAMPLE 6

Table 2 illustrates the biodegradability, thermal and oxidative stability properties of the ester of Example 5 used in a hydraulic fluid with a standard additive package. Biodegradability was tested according to OECD 301 B.

For the thermal stability measurement a modification of ASTM D548-93 was undertaken. 5 mg of test fluid was weighed into an aluminium crucible and placed into a differential scanning calorimeter cell. The cell was closed, and pressurised to 40 bar pressure with air. The back pressure regulator was set at 40 bar (abs.), and the flow regulator set at a flow of 50 ml/min. The sample was then heated to the test temperature of 200° C. at a rate of 50° C./min. The heat flow relative to the sample was recorded against time. When the sample was oxidised, an exothermal peak was shown allowing the oxidation induction time to be calculated.

The oxidative stability was tested according to a modification of DIN test 51587, the modifications being that water was omitted from the test samples, and the change in viscosity at 40° C. was measured over a period of 2600 hours instead of the acid value which could not be measured due to sample colouraton over time.

TABLE 2

| | | | Oxidative |
|---|---|---|---|
| | | | Stability |
| | Biodegradability | Thermal | (Change in |
| Ester | (%) | Stability (min) | viscosity) |
| Example 5 | 97.6 | 234.4 | 3.3 |
| PRIOLUBE | 77.4 | 176.2 | 5.1 |
| 1973 | | | |
| Agrofluid 316M | Not tested | <10 | 2.0 |

PRIOLUBE 1973 is a neopentylglycol dilsostearate available ex Uniqema.

Agrofluid 316M is a mineral oil based hydraulic fluid available ex Mobil. Panolin HLP 46 Synth is an ester based hydraulic fluid available ex Garantol.

Example 5 demonstrates that the use of esters in accordance with the invention have improved biodegradability and thermal and oxidative stability properties with respect to the comparative esters and mineral oil formulations used for hydraulic fluids.

1. An ester or ester composition according to the formula: 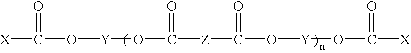
wherein
X is an aliphatic hydrocarbyl group having 5-11 carbon atoms;
Y is an alkylene group having 2-8 carbon atoms;
Z is an aliphatic hydrocarbyl group having 3-5 carbon atoms and
n is a weight average number between 1 and 10.

2. An ester as claimed in claim 1 wherein the ester has a kinematic viscosity at 100° C. of less than 20 mm²/s and a kinematic viscosity at 40° C. of less than 150 mm²/s.

3. An ester as claimed in either of claims 1 or 2 wherein X is saturated and linear and has 7-9 carbon atoms, Y is saturated and branched and has 4-6 carbon atoms, Z is saturated and linear and has 4 carbon atoms, and n is 1.5-5.

4. Use of an ester or ester composition as claimed in any of claims 1-3 as or in hydraulic fluids or metal working fluids.

5. A process for preparing an ester or ester composition as claimed in any of claims 1-3, by reacting together a monocarboxylic acid having a group X, a diol having a group Y and a dicarboxylic acid having a group Z, wherein the ratio of OH groups and COOH groups in the reaction mixture, at the start of the reaction, is 0.9:1-1.1:1 and the ratio of COOH groups from monocarboxylic acid to the dicarboxylic acid in the reaction mixture, at the start of the reaction, is 0.3:1-1.5:1.
